(19) United States
(12) Patent Application Publication
(10) Pub. No.: US 2013/0310488 A1
(43) Pub. Date: Nov. 21, 2013

(54) DUST REDUCER AGENT FOR DRY MIXERS OF BUILDING MATERIAL FORMULATIONS

(71) Applicants: Harald Zeh, Burghausen (DE); Juergen Bezler, Burghausen (DE); Peter Fritze, Haiming (DE)

(72) Inventors: Harald Zeh, Burghausen (DE); Juergen Bezler, Burghausen (DE); Peter Fritze, Haiming (DE)

(73) Assignee: WACKER CHEMIE AG, Muenchen (DE)

(21) Appl. No.: 13/982,257

(22) PCT Filed: Jan. 25, 2012
(86) PCT No.: PCT/EP12/51169

§ 371 Date: Jul. 27, 2013

(30) Foreign Application Priority Data
Jan. 27, 2011 (DE) 10 2011 003 268.1

(51) Int. Cl. C04B 24/42

(52) U.S. Cl. CPC C04B 24/42
USPC 524/5

(57) ABSTRACT

The invention provides methods for producing building material formulations in the form of dry mixers, characterized in that (a) one or more dust reducer agents are applied to one or more inorganic supports, to form supported dust reducer agents, the inorganic supports having a porosity of ≧65%, and the dust reducer agents being selected from the group consisting of fatty acids, fatty acid derivatives, natural oils, hydrocarbons and polysiloxanes composed of units of the general formula R_{c}Si (OR′)_{d}(OH)ₑO_{(4-c-d-e)/2} with c=0 to 3, d=0 to 3, e=0 to 3, in which the sum c+d+e is not more than 3.5 per unit, in which each R is identical or different and denotes branched or unbranched, optionally substituted hydrocarbon radicals having 1 to 22 carbon atoms, R′ denotes identical or different, optionally substituted hydrocarbon radicals having in each case 1 to 6 carbon atoms, and (b) the supported dust reducer agents obtained in step (a) are mixed with one or more mineral binders, one or more polymers based on one or more ethylenically unsaturated monomers, optionally one or more fillers and optionally one or more additives.

The invention relates to methods for producing building material formulations in the form of dry mixes, to the building material formulations obtainable accordingly, and to their use more particularly as tile adhesives or filling compounds.

Many building material formulations comprise hydraulically setting binders, such as cement, and also optionally fillers and optionally adjuvants, such as binders based on ethylenically unsaturated monomers. Building material formulations of this kind find application, for example, as tile adhesives, joint fillers, filling compounds, grouts, plasters, or screeds. Building material formulations are frequently produced by mixing of their dry constituents in a mixer, in the form of dry mixes, and are supplied as ready-to-use products to the building site, where the building material formulations are then processed, following addition of water, as material for building. A disadvantage is that the handling of the dry mixes, as for example during their production or else during dispensing or filling processes, results in dust emissions, which are harmful to health, and so extensive and costly workplace safety measures must be taken to protect the construction workers.

For these reasons, numerous approaches have been taken to reduce the dust emission involved in the handling of dry mixes. Thus, for example, attempts have been made to reduce the development of dust by hydraulically setting binders by way of their degree of grinding and/or grain composition. Nevertheless, the processing qualities of coarser powders are significantly poorer. The addition of additives with a dust-reducing effect is also known. Such dust reducer agents can be incorporated with the mixing water into cementicious building material formulations in order to reduce the dusting that accompanies application of spray-applied concrete or mortar. Polyethylene glycols or ethylene oxide/propylene oxide block copolymers have been employed for this purpose. Additives of these kinds, however, in many cases have an adverse influence on the processing behavior of the building material formulations, since they lead, for example, to retarded setting or to pronounced hygroscopicity in the building material formulations.

Known from WO 2006/084588 is the use of aliphatic hydrocarbons, such as mineral oil or liquid paraffin, as dust reducer agents for building material formulations. The hydrocarbons are applied to the dry mixes of the building material formulations by spraying. However, the dry mix manufacturers are required to acquire special spraying machines and atomizing equipment dedicated to this process, and this constitutes a considerable cost and complication factor. For the same process, DE 202006016797U1 recommends, as alternative dust reducer agents, alcohols, cellulose ethers, or fatty acid ethers, and WO 2010/119017 recommends esters of 2-ethylhexanoic acid with high-boiling alcohols, such as heptanol, dodecanol, or propanediol. WO 2010/097337 recommends vegetable oils as dust reducer agents, and blends them with the other components of building material formulations.

Against this background, the object was to provide alternative measures for incorporation of dust reducer agent into dry building material formulations, with which the dust reducer agents can be incorporated efficiently into the dry formulations without the need for additional worksteps in producing the building material formulations, or for acquisition of additional equipment, such as spraying machines or atomizing equipment. Moreover, further dust reducer agents ought to be provided that reduce the dusting associated with the handling of the dry mixes. The dry building material formulations comprising dust reducer agents ought also to be stable on storage, and more particularly the dust reducer agents in such dry formulations ought not to lose their dust-reducing action during storage, as is frequently the case with common dust reducer agents.

The object has surprisingly been achieved by the dust reducer agents having first been applied to inorganic supports with a porosity of ≧65% and having been incorporated in this form into the building material formulations. The dust reducer agents here are selected from the group encompassing polysiloxanes, fatty acids, fatty acid derivatives, natural oils, and hydrocarbons.

Polysiloxanes or fatty acid compounds have to date been used for imparting water repellency to building material formulations, as described in WO 2005/118684, for example. To prevent the incidence of caking when using liquid water repellency agents, EP 0919526 recommends the application of the water repellency agents to silica supports and their consequent conversion into a solid additive with no propensity toward caking. Water repellency agents described are a very wide variety of silicon compounds, such as alkoxysilanes, organosiloxanes, or alkali metal siliconates. There is, however, no direct description of building material formulations in the form of dry mixes that comprise polysiloxanes applied to supports. EP 1120384 discloses the use of H-siloxanes as water repellency agents. EP 0765899 as well recommends applying liquid adjuvants to supports and incorporating the resulting solid additives into building material formulations.

The invention provides methods for producing building material formulations in the form of dry mixes, characterized in that

(a) one or more dust reducer agents are applied to one or more inorganic supports,
to form supported dust reducer agents,
the inorganic supports having a porosity of ≧65%, and
the dust reducer agents being selected from the group encompassing fatty acids, fatty acid derivatives, natural oils, hydrocarbons, and polysiloxanes constructed from units of the general formula R_{c}Si(OR′)_{d}(OH)ₑO_{(4-c-d-e)/2} with c=0 to 3, d=0 to 3, e=0 to 3, in which the sum c+d+e per unit is not more than 3.5, in which in each case R is identical or different and denotes branched or unbranched, optionally substituted hydrocarbon radicals having 1 to 22 carbon atoms, and R′ denotes identical or different, optionally substituted hydrocarbon radicals having in each case 1 to 6 carbon atoms, and
(b) the supported dust reducer agents obtained in step (a) are mixed with one or more mineral binders, one or more polymers based on one or more ethylenically unsaturated monomers, optionally one or more fillers, and optionally one or more additives.

The invention further provides building material formulations in the form of dry mixes obtainable by the aforementioned method.

Polysiloxanes preferred as dust reducer agents are composed of units of the general formula R_{c}Si(OR′)_{d}(OH)ₑO_{(4-c-d-e)/2} with c=0 to 3, d=0 to 3, e=0 to 3, and with the sum c+d+e being per unit not more than 3.5, in which in each case R is identical or different and denotes branched or unbranched alkyl radicals having 1 to 22 C atoms, cycloalkyl radicals having 3 to 10 C atoms, alkylene radicals having 2 to 4 C atoms, and also aryl, aralkyl, and alkylaryl radicals having 6 to 18 C atoms, and R′ denotes identical or different alkyl radicals and alkoxyalkylene radicals having in each case 1 to 4 C atoms, preferably methyl and ethyl, where the radicals R and R′ may also be substituted by halogens such as chlorine, and by ether, thioether, ester, amide, nitrile, hydroxyl, amine, carboxyl, sulfonic acid, carboxylic anhydride, and carbonyl groups.

Particularly preferred polysiloxanes conform to the general formula R′″ₐR″₃₋ₐ, SiO(SiR″₂O)ₙSiR″₃₋ₐ, R′″ₐ, in which the individual radicals R″ independently of one another may adopt the definitions indicated earlier on above for R and (OR′), and R′″ is OH, a denotes an integral value between 0 and 3, and n adopts an integral value between 0 and 500.

Preferred radicals R″ are methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as n-hexyl radical, heptyl radicals such as n-heptyl radical, octyl radicals such as the n-octyl radical and isooctyl radicals, such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl, and methylcyclohexyl radicals. With particular preference the radicals R″ are monovalent hydrocarbon radicals having 1 to 6 carbon atoms, such as methyl, ethyl, n-propyl, isopropyl, n-butyl, sec-butyl, amyl, and hexyl radicals, with the methyl radical being the most preferred.

Preferred alkoxy radicals R″ are those having 1 to 6 carbon atoms such as methoxy, ethoxy, propoxy, and n-butoxy radical, which optionally may also be substituted by oxyalkylene radicals such as oxyethylene or oxymethylene radicals. Particularly preferred are the methoxy radical and ethoxy radical. The stated alkyl radicals and alkoxy radicals R″ may optionally also be substituted by halogen, mercapto groups, epoxy-functional groups, carboxyl groups, keto groups, enamine groups, amino groups, aminoethylamino groups, isocyanato groups, aryloxy groups, alkoxysilyl groups, and hydroxyl groups.

a stands preferably for the integral values 1 or 2 and more preferably for 1.

n stands preferably for integral values between 0 and 200, even more preferably for integral values between 1 and 100, with particular preference for integral values between 1 and 50, even more preferably for integral values between 1 and 25, and most preferably for integral values between 1 and 15.

Most preferred polysiloxanes are dimethylpolysiloxanes, more particularly dimethylpolysiloxanes endblocked with trimethylsiloxy groups, or dimethylpolysiloxanes having Si—OH groups in the terminal units. Also preferred are mixtures of linear or branched unfunctionalized dimethylpolysiloxanes. The polysiloxanes preferably do not carry any ethylenically unsaturated group.

The dynamic viscosity of the polysiloxanes is preferably 0.1 to 500 mPas, more preferably 0.5 to 360 mPas, very preferably to 100 mPas, even more preferably 1 to 50 mPas, and most preferably 2 to 25 mPas (determined in accordance with ISO3104 at 25° C.).

The surface tension of the polysiloxanes is preferably 15 to 45 mPas, more preferably 15 to 22 mPas, very preferably 16 to mPas, even more preferably 16 to 20 mPas, and most preferably 16 to 19 mPas (determined in accordance with DIN53914 at 25° C.).

Preferred fatty acids or fatty acid derivatives are selected from the group encompassing saturated and unsaturated fatty acids having 8 to 22 C atoms, their metal soaps, their amides, and also their esters with monohydric alcohols having 1 to 14 C atoms, with glycol, with polyglycol, with polyalkylene glycol, with glycerol, with mono-, di-, or triethanolamine, with monosaccharides, and with polyhydroxy compounds.

Particularly preferred fatty acids are lauric acid (n-dodecanoic acid), myristic acid (n-tetradecanoic acid), palmitic acid (n-hexadecanoic acid), stearic acid (n-octadecanoic acid), and oleic acid (9-dodecenoic acid).

Particularly preferred metal soaps are those of the preferred C₈ to C₂₂ fatty acids with metals from main groups 1 to 3 or transition group 2 of the PTE, and also with ammonium compounds NX₄⁺, where X is identical or different and stands for H, C₁ to C₈ alkyl radical, and C₁ to C₈ hydroxyalkyl radical. Those most preferred are metal soaps with lithium, sodium, potassium, magnesium, calcium, aluminum, zinc, and the ammonium compounds.

Particularly preferred fatty acid amides are the fatty acid amides obtainable with mono- or diethanolamine and with the abovementioned C₈ to C₂₂ fatty acids.

Particularly preferred fatty acid esters are the C₁ to C₁₄ alkyl esters and alkylaryl esters of the stated C₈ to C₂₂ fatty acids, preferably methyl, ethyl, propyl, butyl, ethylhexyl esters, and also the benzyl ester. Particularly preferred fatty acid esters are also the mono-, di-, and polyglycol esters of C₈ to C₂₂ fatty acids. Further particularly preferred fatty acid esters are the monoesters and diesters of polyglycols and/or polyalkylene glycols with up to 20 oxyalkylene units, such as polyethylene glycol and polypropylene glycol. Also particularly preferred are the mono-, di-, and tri-fatty acid esters of glycerol with the stated C₈ to C₂₂ fatty acids, and also the mono-, di-, and tri-fatty acid esters of mono-, di-, and triethanolamine with the stated C₈ to C₂₂ fatty acids. Particularly preferred also are the fatty acid esters of sorbitol and mannitol. Particularly preferred are the C₁ to C₁₄ alkyl esters and alkylaryl esters of lauric acid and of oleic acid, mono- and diglycol esters of lauric acid and of oleic acid, and also the mono-, di-, and tri-fatty acid esters of glycerol with lauric acid and with oleic acid.

Natural oils generally comprise one or more carboxylic acids or their esters with alcohols. The carboxylic acids mostly contain 4 to 28 carbon atoms. The alcohols typically contain 1 to 12, more particularly 2 to 12, carbon atoms. The natural oils may be native, cold-pressed, refined, or unrefined. Examples of natural oils are, in particular, vegetable oils, such as sunflower oil, rapeseed oil, peanut oil, walnut oil, hemp oil, coconut oil, pumpkin oil, linseed oil, maize germ oil, poppy oil, olive oil, palm oil, sesame oil, cotton oil, mustard oil or soya oil.

Hydrocarbons stand for substances which generally consist essentially of carbon atoms and hydrogen atoms. Hydrocarbons frequently take the form of hydrocarbon mixtures. The hydrocarbons are preferably aliphatic hydrocarbons or hydrocarbon mixtures, more particularly linear or branched, preferably linear, saturated or unsaturated hydrocarbons or hydrocarbon mixtures, preferably saturated aliphatic hydrocarbons or hydrocarbon mixtures.

The hydrocarbons have boiling points or boiling ranges of preferably 100 to 400° C., more particularly 150 to 350° C., more preferably from 200 to 300° C., based in each case on pressure of 1 bar. The hydrocarbons preferably have more than 10 carbon atoms, more particularly more than 15 carbon atoms, and very preferably more than 20 carbon atoms. Also preferred are hydrocarbons having 10 to 100, more preferably 10 to 40, and most preferably from 15 to 30 carbon atoms. The hydrocarbons have weight-average molecular masses of preferably 100 to 4000 g/mol, more preferably of 100 to 2000 g/mol, even more preferably of 150 to 1000 g/mol, and most preferably of 250 to 500 g/mol.

As dust reducer agents, fatty acids or fatty acid derivatives are preferred, hydrocarbons particularly preferred, and polysiloxanes being most preferred.

The inorganic supports are based preferably on natural or synthetic carbonates, silicates, or other inorganic oxides or minerals.

Examples of carbonates are magnesium carbonate or calcium carbonate. Examples of silicates are quartz, cristobalite, fumed or precipitated silica, more particularly highly disperse silica, diatomaceous earth, kieselguhr, siliceous earth, magnesium hydrosilicates, microsilica, perlite, Dicalite, zeolites or Poraver (foam glass).

Other inorganic oxides are preferably oxides of titanium, zirconium, aluminum, boron, or phosphorus. Examples of other inorganic oxides or minerals are titanium dioxide, alumina, bleaching earths, kaolin, talc, mica, activated aluminum oxide, vermiculites, such as bentonite, or phosphates, such as sodium phosphate.

With particular preference the inorganic supports are based on calcium carbonate, calcite, chalk, dolomite, quartz, cristobalite, kaolin, talc, mica, fumed or precipitated silica, more particularly highly disperse silica, diatomaceous earth, kieselguhr, siliceous earth, microsilica, perlite, Dicalite, zeolites or Poraver (foam glass).

Most preferably the inorganic supports are based on perlite, Dicalite, zeolites, or silica, such as fumed or precipitated silica.

The inorganic supports are therefore preferably based not on mineral binders, and in particular, also not on the mineral binders set out later on below.

Key to the present invention is the physical quality of the inorganic supports. The required physical quality is characterized by the porosity of the inorganic supports. The porosity represents the ratio of cavity volume of the inorganic supports to their total volume. The porosity is determined by means of mercury porosimetry using the Micrometrics AutoPore IV mercury porosimeter in accordance with ISO 15901, using a filling pressure of 10.3 kPa. This method of determination is referred to below as mercury porosimetry.

The inorganic supports have a porosity of preferably ≧70%, more preferably ≧75%, and most preferably ≧80% (determined by means of mercury porosimetry). The porosity of the inorganic supports here is preferably ≦95% and more preferably ≦90% (determined by means of mercury porosimetry).

In the inorganic supports the fraction of the pores having a pore diameter of ≧2000 nm is preferably ≧10%, more preferably ≧25%, even more preferably ≧30%, very preferably ≧35%, and most preferably ≧40%, based in each case on the total number of pores in the inorganic supports. In the inorganic supports the fraction of the pores having a pore diameter of ≧20 000 nm is preferably ≧5%, more preferably ≧15%, very preferably ≧20%, and most preferably ≧25%, based in each case on the total number of pores in the inorganic supports. The determination is made in each case by means of mercury porosimetry.

The inorganic supports have a BET surface area of preferably ≧1 m²/g, more preferably ≧2 m²/g, even more preferably ≧5 m²/g, very preferably ≧10 m²/g, and most preferably ≧15 m²/g (DIN EN ISO 9277:2003-5).

The inorganic supports have a density of preferably 50 to 300 g/dm³ and more preferably of 80 to 250 g/dm³ (determination in accordance with DIN EN ISO 787-10).

The particle size of the inorganic supports is preferably from 0.005 to 3000 μm, more preferably from 1 to 1000 μm, and most preferably 10 to 500 μm.

The inorganic supports are present generally in the form of powders.

Particularly preferred are inorganic supports with a liquid absorption of 10 to 75 wt %, more particularly 15 to 75 wt %, based on the total weight of the inorganic supports. The liquid absorption of such supports may be determined using commonplace techniques, as for example by determining the DOP absorption in analogy to DIN 53417, or by determining the mercury porosity with instruments such as AutoPore IV.

The supported dust reducer agents contain preferably 5 to 90 wt % and more preferably 10 to 66 wt % of inorganic supports, based on the total weight of the dust reducer agents and inorganic supports.

The supported dust reducer agents contain preferably 10 to 95 wt %, more preferably 20 to 70 wt %, and most preferably 40 to 70 wt % of dust reducer agents, based on the total weight of the inorganic supports.

Application of the dust reducer agents to the inorganic supports may be accomplished by spraying, dropwise application, or mixing of the aforementioned components. Preference is given to sprayed or dropwise application of the dust reducer agents to the inorganic supports. Particularly preferred is sprayed or dropwise application with simultaneous stirring or mixing.

The dust reducer agents are applied preferably as the pure substance, especially if the dust reducer agents are in liquid or melted form. In this way, homogeneous application can be ensured simply and at the same time with effective attachment and initial adhesion. The dust reducer agents can also be used in the form of solids. Lastly, it is also possible, albeit less preferable, to employ the dust reducer agents in the form of a solution, suspension, or emulsion, optionally in water. If solvent is used it may be useful to dry the supported dust reducer agents. The supported dust reducer agents contain preferably ≦5 wt % of water, based on the total weight of the supported dust reducer agents, and more preferably substantially no water. No water means that no water is added to the starting materials for producing the supported dust reducer agents.

The sprayed or dropwise application of the dust reducer agents to the inorganic supports takes place with use of commonplace spraying nozzles.

Mixing may take place in any desired apparatus suitable for powder mixtures. Suitable mixers are, for example, continuous and batchwise-operating ribbon mixers, double helix mixers, blade mixers, plowshare mixers, and fast- or slow-running paddle mixers. Mention may also be made of vortex screw mixers and pan mixers. Mixers having rotating mixing vessels can be used as well, such as drum hoop mixers, tumble mixers, double cone mixers, and V mixers.

Application of the dust reducer agents to the inorganic supports takes place generally at room temperature. In a variety of instances, however, it is advantageous to undertake this operation at elevated temperature. This is the case especially when the viscosity of the liquid or pastelike dust reducer agents at room temperature is too high for their uniform incorporation; when the dust reducer agents have a melting point barely above the room temperature; or when the dust reducer agents are to be wholly or partly dissolved in the support substance.

Generally speaking, it is advantageous to introduce the inorganic supports first and to meter in the dust reducer agents, very preferably by sprayed or dropwise application. Application may also take place continuously.

The supported dust reducer agents are generally present in a solid form. Alternatively the supported dust reducer agents may be in paste form.

Suitable mineral binders are, for example, cement, more particularly portland cement, aluminate cement, especially calcium sulfoaluminate cement, trass cement, slag cement, magnesia cement, phosphate cement, or blast furnace cement, and also mixed cements, filling cements, fly ash, slag sand, lime hydrate, white lime hydrate, calcium oxide (unslaked lime) and gypsum, such as alpha-hemihydrate, beta-hemihydrate, anhydrite, or CaSO4 dihydrate. Preference is given to portland cement, aluminate cement, and slag cement, and also to mixed cements, filling cements, lime hydrate, white lime hydrate, or gypsum, such as alpha-hemihydrate or anhydrite.

Preferably, therefore, mineral binders do not include silicates. The building material formulations of the invention are therefore preferably not silicate plasters.

The polymers are based on one or more ethylenically unsaturated monomers, such as, for example, on one or more ethylenically unsaturated monomers selected from the group encompassing vinyl esters, (meth)acrylic esters, vinylaromatics, olefins, 1,3-dienes, and vinyl halides, and optionally further monomers copolymerizable therewith.

Suitable vinyl esters are, for example, those of carboxylic acids having 1 to 15 C atoms. Preferred are vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 C atoms, as for example VeoVa9^{R} or VeoVa10^{R} (trade names of the company Resolution). Particularly preferred is vinyl acetate.

Suitable monomers from the group of acrylic esters or methacrylic esters are, for example, esters of unbranched or branched alcohols having 1 to 15 C atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, 2-ethylhexyl acrylate. Particularly preferred are methyl acrylate, methyl methacrylate, n-butyl acrylate, t-butyl acrylate, and 2-ethylhexyl acrylate.

Preferred vinylaromatics are styrene, methylstyrene, and vinyltoluene. A preferred vinyl halide is vinyl chloride. The preferred olefins are ethylene, propylene, and the preferred dienes are 1,3-butadiene and isoprene.

Optionally it is also possible for 0 to 10 wt % of auxiliary monomers to be copolymerized, based on the total weight of the monomer mixture. It is preferred to use 0.1 to 5 wt % of auxiliary monomers. Examples of auxiliary monomers are ethylenically unsaturated monocarboxylic and dicarboxylic acids, preferably acrylic acid, methacrylic acid, fumaric acid, and maleic acid; ethylenically unsaturated carboxamides and carbonitriles, preferably acrylamide and acrylonitrile; monoesters and diesters of fumaric acid and maleic acid such as the diethyl and diisopropyl esters and also maleic anhydride; ethylenically unsaturated sulfonic acids and their salts, preferably vinylsulfonic acid, 2-acrylamido-2-methylpropanesulfonic acid. Further examples are precrosslinking comonomers such as polyethylenically unsaturated comonomers, as for example diallyl phthalate, divinyl adipate, diallyl maleate, allyl methacrylate, or triallyl cyanurate, or postcrosslinking comonomers, as for example acrylamidoglycolic acid (AGA), methylacrylamidoglycolic acid methyl ester (MAGME), N-methylolacrylamide (NMA), N-methylolmethacrylamide, N-methylolallyl carbamate, alkyl ethers such as the isobutoxy ether or esters of N-methylolacrylamide, of N-methylolmethacrylamide, and of N-methylolallyl carbamate. Also suitable are epoxide-functional comonomers such as glycidyl methacrylate and glycidyl acrylate. Other examples are silicon-functional comonomers, such as acryloyloxypropyltri(alkoxy)- and methacryloyloxypropyltri(alkoxy)silanes, vinyltrialkoxysilanes, and vinylmethyldialkoxysilanes, in which alkoxy groups present may be ethoxy and ethoxypropylene glycol ether radicals, for example. Mention may also be made of monomers having hydroxyl or CO groups, examples being methacrylic and acrylic hydroxyalkyl esters such as hydroxyethyl, hydroxypropyl, or hydroxybutyl crylate or methacrylate, and also compounds such as diacetoneacrylamide and acetylacetoxyethyl acrylate or methacrylate.

Preferred are one or more polymers selected from the group encompassing vinyl ester homopolymers, vinyl ester copolymers containing one or more monomer units from the group encompassing vinyl esters, olefins, vinylaromatics, vinyl halides, acrylic esters, methacrylic esters, fumaric and/or maleic monoesters or diesters; (meth)acrylic ester homopolymers, (meth)acrylic ester copolymers containing one or more monomer units from the group encompassing methacrylic esters, acrylic esters, olefins, vinylaromatics, vinyl halides, fumaric and/or maleic monoesters or diesters; homopolymers or copolymers of dienes such as butadiene or isoprene, and also of olefins such as ethene or propene, where the dienes may be copolymerized, for example, with styrene, (meth)acrylic esters, or the esters of fumaric or maleic acid; homopolymers or copolymers of vinylaromatics, such as styrene, methylstyrene, vinyltoluene; homopolymers or copolymers of vinyl halogen compounds such as vinyl chloride, in which case the polymers may additionally comprise auxiliary monomers.

Particularly preferred are copolymers of one or more vinyl esters with 1 to 50 wt % of ethylene; copolymers of vinyl acetate with 1 to 50 wt % of ethylene and 1 to 50 wt % of one or more further comonomers from the group of vinyl esters having 1 to 12 C atoms in the carboxylic acid radical such as vinyl propionate, vinyl laurate, vinyl esters of alpha-branched carboxylic acids having 9 to 13 C atoms such as VeoVa9, VeoVa10, VeoVa11; copolymers of one or more vinyl esters, 1 to 50 wt % of ethylene, and preferably 1 to 60 wt % of (meth)acrylic esters of unbranched or branched alcohols having 1 to 15 C atoms, more particularly n-butyl acrylate or 2-ethylhexyl acrylate; and copolymers with 30 to 75 wt % of vinyl acetate, 1 to 30 wt % of vinyl laurate, or vinyl esters of an alpha-branched carboxylic acid having 9 to 11 C atoms, and also 1 to 30 wt % of (meth)acrylic esters of unbranched or branched alcohols having 1 to 15 C atoms, more particularly n-butyl acrylate or 2-ethylhexyl acrylate, which further comprise 1 to 40 wt % of ethylene; copolymers with one or more vinyl esters, 1 to 50 wt % of ethylene, and 1 to 60 wt % of vinyl chloride; the polymers may further comprise the stated auxiliary monomers in the stated amounts, and the figures in wt % add up to 100 wt % in each case.

Particular preference is also given to (meth)acrylic ester polymers, such as copolymers of n-butyl acrylate or 2-ethylhexyl acrylate or copolymers of methyl methacrylate with n-butyl acrylate and/or 2-ethylhexyl acrylate; styrene-acrylic ester copolymers with one or more monomers from the group of methyl acrylate, ethyl acrylate, propyl acrylate, n-butyl acrylate, 2-ethylhexyl acrylate; vinyl acetate-acrylic ester copolymers with one or more monomers from the group of methyl acrylate, ethyl acrylate, propyl acrylate, n-butyl acrylate, 2-ethylhexyl acrylate, and—optionally—ethylene; styrene-1,3-butadiene copolymers; the polymers may further comprise auxiliary monomers in the stated amounts, and the figures in wt % add up to 100 wt % in each case.

Examples of particularly preferred comonomers for vinyl chloride copolymers are α-olefins, such as ethylene or propylene, and/or vinyl esters, such as vinyl acetate, and/or acrylic esters and/or methacrylic esters of alcohols having 1 to 15 C atoms, such as methyl acrylate, methyl methacrylate, ethyl acrylate, ethyl methacrylate, propyl acrylate, propyl methacrylate, n-butyl acrylate, t-butyl acrylate, n-butyl methacrylate, t-butyl methacrylate, 2-ethylhexyl acrylate, and/or fumaric and/or maleic monoesters or diesters such as the dimethyl, methyl t-butyl, di-n-butyl, di-t-butyl, and diethyl esters of maleic acid and/or fumaric acid.

The most preferred are copolymers with vinyl acetate and 5 to 50 wt % of ethylene; or copolymers with vinyl acetate, 1 to 50 wt % of ethylene, and 1 to 50 wt % of a vinyl ester of α-branched monocarboxylic acids having 9 to 13 C atoms; or copolymers with 30 to 75 wt % of vinyl acetate, 1 to 30 wt % of vinyl laurate or vinyl esters of an alpha-branched carboxylic acid having 9 to 11 C atoms, and also 1 to 30 wt % of (meth)acrylic esters of unbranched or branched alcohols having 1 to 15 C atoms, which further comprise 1 to 40 wt % of ethylene; or copolymers with vinyl acetate, 5 to 50 wt % of ethylene, and 1 to 60 wt % of vinyl chloride.

The most preferred copolymers are also vinyl chloride-ethylene copolymers comprising 60 to 98 wt % of vinyl chloride units and 1 to 40 wt % of ethylene units, the figures in wt % being based on the total weight of the copolymer and adding up in each case to 100 wt %. Vinyl chloride-ethylene copolymers of this kind are known from EP 0 149 098 A2.

The monomer selection and the selection of the weight fractions of the comonomers are made so as to result in a glass transition temperature, Tg, of −50° C. to +30° C., preferably −40° C. to +10° C., more preferably −30° C. to 0° C. The Tg glass transition temperature of the polymers can be determined in a known way by means of differential scanning calorimetry (DSC). The Tg may also be calculated approximately in advance by means of the Fox equation. According to Fox T. G., Bull. Am. Physics Soc. 1, 3, page 123 (1956) it is the case that: 1/Tg=x1/Tg1+x2/Tg2+ . . . +xn/Tgn, where xn is the mass fraction (wt %/100) of the monomer n, and Tgn is the glass transition temperature, in kelvins, of the homopolymer of the monomer n. Tg values for homopolymers are listed in Polymer Handbook 2nd Edition, J. Wiley & Sons, New York (1975).

The preparation of the polymers on the basis of ethylenically unsaturated monomers may take place by bulk or solution polymerization processes or, preferably, by emulsion or suspension polymerization processes. The emulsion or suspension polymerization is carried out generally in an aqueous medium—as described in DE-A 102008043988, for example. In this case the polymers are obtained in the form of aqueous dispersions. The polymerization may be performed using the commonplace protective colloids and/or emulsifiers, as described in DE-A 102008043988. The protective colloids may be anionic or, preferably, cationic or, more preferably, nonionic. Also preferred are combinations of cationic and nonionic protective colloids. Preferred nonionic protective colloids are polyvinyl alcohols. Preferred cationic protective colloids are polymers which carry one or more cationic charges, as described in E. W. Flick, Water Soluble Resins—an Industrial Guide, Noyes Publications, Park Ridge, N.J., 1991, for example. Preferred as protective colloids are partially hydrolyzed or fully hydrolyzed polyvinyl alcohols having a degree of hydrolysis of 80 to 100 mol %, more particularly partially hydrolyzed polyvinyl alcohols having a degree of hydrolysis of 80 to 94 mol % and a Höppler viscosity, in 4% strength aqueous solution, of 1 to 30 mPas (Höppler method at 20° C., DIN 53015). The stated protective colloids are obtainable by means of processes known to the skilled person and are added generally in an amount of 1 to 20 wt % in total, based on the total weight of the monomers, during the polymerization.

The polymers in the form of aqueous dispersions may be converted as described in DE-A 102008043988 into corresponding water-redispersible powders. Appropriate drying of the polymer dispersions hence produces polymers in the form of water-redispersible powders. In this case, in general, a drying aid is used, in a total amount of 3 to 30 wt %, preferably 5 to 20 wt %, based on the polymeric constituents of the dispersion. Preferred drying aids are the aforementioned polyvinyl alcohols.

The polymers are used preferably in the form of water-redispersible powders.

Examples of suitable fillers for the building material formulations are quartz sand, finely ground quartz, finely ground limestone, calcium carbonate, dolomite, clay, chalk, white lime hydrate, talc, or mica, granulated rubber or hard fillers, such as aluminum silicates, corundum, basalt, carbides, such as silicon carbide or titanium carbide, or fillers which give a pozzolanic reaction, such as fly ash, metakaolin, microsilica, or diatomaceous earth. Preferred fillers are quartz sand, finely ground quartz, finely ground limestone, calcium carbonate, calcium magnesium carbonate (dolomite), chalk, or white lime hydrate.

Also preferred is the use of lightweight fillers. Lightweight fillers are those fillers having a low bulk density, usually of less than 500 g/l. Typical lightweight fillers, on a synthetic or natural basis, are substances such as hollow glass microbeads, polymers such as polystyrene beads, aluminosilicates, silicon oxide, aluminum silicon oxide, calcium silicate hydrate, silicon dioxide, aluminum silicate, magnesium silicate, aluminum silicate hydrate, calcium aluminum silicate, calcium silicate hydrate, aluminum iron magnesium silicate, calcium metasilicate and/or volcanic slag. The form of the lightweight fillers is not limited and they may in particular have a spherical, plateletlike, rodlet-shaped and/or lamellar structure. Preferred lightweight fillers are perlites, Celite, Cabosil, Circosil, Eurocell, Fillite, Promaxon, Vermex and/or wollastonites, and also polystyrene.

Optionally it is possible in addition to use additives, for the purpose, for example, of improving consistency, processing qualities, open time, or water resistance. Typical additives for the building material formulations are thickeners, examples being polysaccharides such as cellulose ethers and modified cellulose ethers, starch ethers, guar gum, xanthan gum, polycarboxylic acids such as polyacrylic acid and partial esters thereof, and also polyvinyl alcohols which may optionally have been acetalized or hydrophobically modified; casein; and associative thickeners. Other common additives are crosslinkers such as metal or semimetal oxides, more particularly boric acid or polyborates, or dialdehydes, such as glutaraldehyde. Customary additives are also retardants, such as hydroxycarboxylic acids, dicarboxylic acids or salts thereof, saccharides or polyols, more particularly oxalic acid, succinic acid, tartaric acid, gluconic acid, citric acid, sucrose, glucose, fructose, sorbitol or pentaerythritol. Further additives are also setting accelerators, examples being aluminum compounds, silicates, alkali metal hydroxides, carbonates, or salts of carboxylic acid. Preferred setting accelerators are aluminum salts, aluminates, alkali metal or alkaline earth metal silicates, such as waterglass, for example, alkali metal or alkaline earth metal carbonates, or potassium hydroxide, or alkali metal or alkaline earth metal salts of inorganic or organic acids, such as, in particular, salts of organic monocarboxylic acids. Particularly preferred setting accelerators are aluminum sulfate, alkali metal aluminates such as potassium aluminate, aluminum hydroxides, potassium carbonate, sulfoaluminates, such as calcium sulfoaluminate, for example, or alkali metal and alkaline earth metal salts of carbonates or formates. The following may also be mentioned: preservatives, film-forming assistants, dispersants, foam stabilizers, defoamers, plasticizers, flow agents, and flame retardants (e.g., aluminum hydroxide).

Typical formulas for the building material formulations include preferably 2 to 70 wt %, more preferably 10 to 70 wt %, of mineral binders, more particularly cement, optionally in combination with aluminate cement for quick-setting systems; preferably 0.001 to 10 wt %, more preferably 0.01 to 5 wt %, and most preferably 0.1 to 4 wt % of supported dust reducer agents; preferably 1 to 60 wt %, more preferably 1 to 10 wt %, of polymers; preferably 10 to 85 wt %, more preferably 30 to 85 wt %, of fillers; the figures in wt % are based on the dry weight of the building material formulations and add up in total to 100 wt %.

The dust reducer agents are present in the building material formulations preferably at 0.001 to 5 wt % and more preferably at 0.01 to 2 wt %, based on the dry weight of said formulations.

The proportion of additives in the building material formulations is generally in total 0 to 20 wt %, preferably 0.1 to 15 wt %, and more preferably 0.1 to 10 wt %, based in each case on the dry weight of the building material formulations.

The production of the building material formulations is not tied to any particular procedure or mixing apparatus. Building material formulations are obtainable by mixing and homogenizing the individual constituents of the building material formulations in conventional powder mixing equipment, as for example by means of mortar mixers, concrete mixers, or plaster machines or stirrers. Building material formulations are obtainable, accordingly, by mixing one or more supported dust reducer agents, one or more mineral binders, optionally one or more fillers, optionally one or more polymers, and optionally one or more additives.

The building material formulations are therefore in the form of dry mixes.

In an alternative procedure, premixes are produced first of all. Premixes comprise preferably one or more supported dust reducer agents and one or more components from the group encompassing polymers in the form of water-redispersible powders, fillers, and additives. The building material formulations are then produced by mixing one or more premixes with one or more mineral binders, optionally one or more fillers, optionally one or more polymers, and optionally one or more additives.

The premixes are obtainable by mixing preferably one or more supported dust reducer agents and one or more components from the group encompassing polymers in the form of water-redispersible powders, fillers, and additives with one another. The mixing of the supported dust reducer agents with the aforementioned components may take place continuously or batchwise and generally at room temperature in the abovementioned mixing assemblies. An alternative possibility is for one or more supported dust reducer agents to be mixed with one or more polymers in the form of aqueous dispersions and optionally one or more additives, and to be dried optionally in accordance with the techniques described above for the drying of aqueous polymer dispersions, to form premixes. In the latter case the supported dust reducer agents are preferably added during the drying of the polymer dispersions, more particularly during spray drying. The addition of the supported dust reducer agents preferably, however, takes place after drying; especially preferred is the continuous metered addition of the supported dust reducer agents into the spray drier, after a completed drying operation of the polymer dispersion, optionally together with other adjuvants which can be mixed in conventionally, such as antiblocking agents, defoamers, foam stabilizers, fillers, dyes, biocides, and thickeners, for example.

The drying of dust reducer agents in the presence of polymer dispersions and inorganic supports generally does not lead to the supported dust reducer agents employed in accordance with the invention. It is therefore essential that the dust reducer agents are first applied to the inorganic supports and the resultant supported dust reducer agents are mixed with the other constituents of the building material formulations or with the further components of the premixes.

The proportion of the supported dust reducer agents in the premixes is arbitrary and can be adapted to the requirements in the particular application.

The premixes can then be blended with the other constituents of the building material formulation.

Water is generally added to the building material formulations of the invention before they are applied. The resulting aqueous building material formulations contain preferably 10 to 90 wt % and more preferably 15 to 50 wt % of water, based on the dry weight of the building material formulations.

The building material formulations of the invention are suitable, for example, for use as tile adhesives, jointing mortars, adhesives for producing thermal insulation composite systems, reinforcing compounds, self-leveling compounds, repair mortars, or plasters, fine mineral plasters, grouts, skim coats, or concrete. The inorganic supports are compatible with the other components of the building material formulations and do not adversely affect their performance properties.

The supported dust reducer agents can advantageously be incorporated using commonplace equipment into the building material formulations of the invention without the need to acquire and operate specific atomizing or spraying machines for that purpose. Instead, the supported dust reducer agents can be admixed using the apparatus established among manufacturers of dry building material mixes. The supported dust reducer agents are generally free-flowing and have no propensity toward caking, and this facilitates their storage or processing, more particularly their precise and uniform blending with the further constituents of the dry building material formulations.

It was surprising that even in the supported form the dust reducer agents develop their dust-reducing effect on dry building material mixes. A particular surprise here was that the supported dust reducer agents do not lose their effect as dust reducer agents on dry building material formulations in the course of storage, as is frequently the case with conventional dust reducer agents. With the supported dust reducer agents it is in fact possible to observe an increase in their dust-reducing effect in the course of storage. The supported dust reducer agents are specially suitable for dedusting polymer-containing dry building material formulations. By increasing the amount of supported dust reducer agents in the building material formulations it is possible to raise their dust-reducing effect further.

The following examples serve for detailed elucidation of the invention and should in no way be construed as a restriction.

Properties of the Inorganic Supports Used:

Method for Determining the Porosity of the Inorganic Supports:

Porosity was determined by means of mercury porosimetry using the Micrometrics AutoPore IV mercury porosimeter in accordance with ISO 15901, with a filling pressure of 10.3 kPa (mercury porosimetry).

Calcium Carbonate:

porosity of 57.8% (determined by means of mercury porosimetry); fraction of pores having a pore diameter of ≧2000 nm was 35%, and the fraction of pores having a pore diameter of ≧20 000 nm was 15%, based in each case on the total number of the pores in the calcium carbonate (determined by means of mercury porosimetry);

average particle diameter dp_{average} of 4.5 μm;
BET surface of 2.1 m²/g (determined in accordance with DIN EN ISO 9277:2003-5).

Sipernat 22 (Trade Name of Evonik Industries):

porosity of 85.7% (determined by means of mercury porosimetry);

fraction of pores having a pore diameter of ≧2000 nm was 43%, and the fraction of pores having a pore diameter of ≧20 000 nm was 32%, based in each case on the total number of the pores in the Sipernat 22 (determined by means of mercury porosimetry);

BET surface of 190 m²/g (determined in accordance with DIN EN ISO 9277:2003-5).

Dicalite (Trade Name of Dicalite Europe):

porosity of 88.7% (determined by means of mercury porosimetry); fraction of pores having a pore diameter of ≧2000 nm was 96%, and the fraction of pores having a pore diameter of ≧20 000 nm was 55%, based in each case on the total number of the pores in the Dicalite (determined by means of mercury porosimetry);

BET surface of 1.8 m²/g (determined in accordance with DIN EN ISO 9277:2003-5).

Production of Supported Dust Reducer Agents (Dedusters):

Deduster 1: with Calcium Carbonate as Support (not Inventive):

400 g of calcium carbonate were mixed with 100 g of Siliconöl AK 10 (dimethylpolysiloxane (CH₃)₃Si [OSi(CH₃)₂]8-9OSi(CH₃)₃ with a viscosity of 10 mm²/s, average MW 800 g/mol; trade name of Wacker Chemie) silicone fluid in a paddle mixer with stirring. The resulting deduster 1 contained 75 wt % of calcium carbonate, based on the total weight of the deduster 1.

Deduster 2: with Precipitated Silica as Support (Inventive):

100 g of Siliconöl AK 10 silicone fluid were added via a dropping funnel with stirring to 100 g of Sipernat 22.

Deduster 3: with Precipitated Silica as Support (Inventive):

200 g of Siliconöl AK 10 silicone fluid were added via a dropping funnel with stirring to 100 g of Sipernat 22.

Deduster 4: with Precipitated Silica as Support (Inventive):

200 g of Siliconöl AK 350 (dimethylpolysiloxane (CH₃)₃Si [OSi(CH₃)₂]₁₀₀OSi(CH₃)₃ with a viscosity of 350 mm²/s, average MW about 7000 g/mol; trade name of Wacker Chemie) silicone fluid were added via a dropping funnel with stirring to 100 g of Sipernat 22.

Deduster 5: with Dicalite as Support (Inventive):

200 g of Siliconöl AK 10 silicone fluid were applied via a spray nozzle (gardening accessory) with stirring to 100 g of Dicalite.

Deduster 6: with Dicalite as Support (Inventive):

100 g of Siliconöl AK 10 silicone fluid were applied via a spray nozzle (gardening accessory) with stirring to 100 g of Dicalite.

Deduster 7: with Dicalite as Support (Inventive):

100 g of Siliconöl AK 350 silicone fluid were applied via a spray nozzle (gardening accessory) with stirring to 100 g of Dicalite.

Deduster 8: with Dicalite as Support (Inventive):

200 g of Rapsöl/Rüböl-Raffinat (trade name of D.L.R. Warenhandelsgesellschaft mbH) refined rapeseed oil/colza oil were added via a dropping funnel with stirring to 100 g of Dicalite.

Deduster 9: with Dicalite as Support (Inventive):

200 g of Catenex T121 (mineral oil; trade name of Shell AG) were added via a dropping funnel with stirring to 100 g of Dicalite.

Formulas of the Building Material Formulations:

Formulation 1:

Dry Mortar Formula:

| | |
|---|---|
| Cement CEM I 42.5 | 336.0 parts |
| Quartz sand (0.1-0.4 mm) | 620.2 parts |
| Cellulose ether | 3.8 parts |

About 40 parts of VINNAPAS 8034 H (polyvinyl alcohol stabilized vinyl chloride-vinyl laurate-ethylene copolymer; trade name of Wacker Chemie) dispersion powder, admixed optionally with 1% to 30% of supported dust reducer agent.

Formulation 2:

C1 Tile Adhesive Formula:

| | |
|---|---|
| Cement CEM I 42.5 N | 420 parts |
| Quartz sand (dp_{average} 0.2 mm) | 480 parts |
| Calcium carbonate (dp_{average} 0.065 mm) | 80 parts |
| Cellulose ether | 5 parts |
| Calcium formate | 5 parts |

10 parts of VINNAPAS 5044 N (polyvinyl alcohol stabilized vinyl acetate-ethylene copolymer; trade name of Wacker Chemie) dispersion powder,

optionally 10 parts of supported dust reducer agent.

Formulation 3:

C2 Tile Adhesive Formula:

| | |
|---|---|
| Cement CEM I 52.5 N | 400 parts |
| Quartz sand (dp_{average} 0.17 mm) | 270 parts |
| Quartz sand (dp_{average} 0.33 mm) | 275 parts |
| Cellulose ether | 5 parts |
| Calcium formate | 5 parts |

45 parts of VINNAPAS 5044 N (polyvinyl alcohol stabilized vinyl acetate-ethylene copolymer; trade name of Wacker Chemie) dispersion powder,

optionally 10 parts of supported dust reducer agent.

Production of the Building Material Formulations:

Method A:

The individual components of the respective formula of the building material formulation were weighed out into a closed container (total amount about 3 to 4 kg), so that no dust could escape. The mixture was applied to a roll mixer assembly, together with a 1 kg steel ball, and mixed for an hour. The formulas of the individual inventive and comparative examples are specified below.

Method B:

First of all a premix was produced, by admixing the respective supported dust reducer agent (deduster) to the respective VINNAPAS dispersion powder in a closed paddle mixer.

This premix was subsequently mixed with the further components of the respective formula of the building material formulation in the above-stated roll mixer assembly.

The formulas of the individual inventive and comparative examples are specified below.

### COMPARATIVE AND INVENTIVE EXAMPLES 1 TO 11 AND 16 TO 18

### CEx. 1 to Ex. 11 and Ex. 16 to Ex. 18

The building material formulations of CEx. 1 to Ex. 11 and Ex. 16 to Ex. 18 are based on formulation 1. The amounts of dispersion powder and supported dust reducer agent (deduster), where present, and also the methods for producing the building material formulations, are specified below.

### COMPARATIVE EXAMPLE 1

### CEx. 1

Contained 4 wt % of dispersion powder, but no supported dust reducer agent (deduster), the FIGURE in wt % being based on the total weight of the building material formulation of CEx. 1. The building material formulation was produced by method A.

### COMPARATIVE EXAMPLE 2

### CEx. 2

Contained 4 wt % of dispersion powder, based on the total weight of the building material formulation of CEx. 2.

The building material formulation was produced by method B.
The premix contained 5 wt % of deduster 1, based on the total weight of the premix. The building material formulation therefore contained 0.05 wt % of Siliconöl AK 10, based on the total weight of the building material formulation of CEx. 2.

### COMPARATIVE EXAMPLE 3

### CEx. 3

Contained 4 wt % of dispersion powder, based on the total weight of the building material formulation of CEx. 3.

The building material formulation was produced by method B.
The premix contained 10 wt % of deduster 1, based on the total weight of the premix. The building material formulation therefore contained 0.1 wt % of Siliconöl AK 10, based on the total weight of the building material formulation of CEx. 3.

### INVENTIVE EXAMPLE 4

### Ex. 4

Contained 4 wt % of dispersion powder, based on the total weight of the building material formulation of Ex. 4.

The building material formulation was produced by method B.
The premix contained 2 wt % of deduster 6, based on the total weight of the premix. The building material formulation therefore contained 0.04 wt % of Siliconöl AK 10, based on the total weight of the building material formulation of Ex. 4.

### INVENTIVE EXAMPLE 5

### Ex. 5

Contained 4 wt % of dispersion powder, based on the total weight of the building material formulation of Ex. 5.

The building material formulation was produced by method B.
The premix contained 4 wt % of deduster 6, based on the total weight of the premix. The building material formulation therefore contained 0.08 wt % of Siliconöl AK 10, based on the total weight of the building material formulation of Ex. 5.

### INVENTIVE EXAMPLE 6

### Ex. 6

Contained 4 wt % of dispersion powder, based on the total weight of the building material formulation of Ex. 6.

The building material formulation was produced by method B.
The premix contained 3 wt % of deduster 5, based on the total weight of the premix. The building material formulation therefore contained 0.08 wt % of Siliconöl AK 10, based on the total weight of the building material formulation of Ex. 6.

### INVENTIVE EXAMPLE 7

### Ex. 7

Contained 4 wt % of dispersion powder, based on the total weight of the building material formulation of Ex. 7.

The building material formulation was produced by method B.
The premix contained 30 wt % of deduster 5, based on the total weight of the premix. The building material formulation therefore contained 0.8 wt % of Siliconöl AK 10, based on the total weight of the building material formulation of Ex. 7.

### INVENTIVE EXAMPLE 8

### Ex. 8

Contained 4 wt % of dispersion powder, based on the total weight of the building material formulation of Ex. 8.

The building material formulation was produced by method B.
The premix contained 3 wt % of deduster 7, based on the total weight of the premix. The building material formulation therefore contained 0.06 wt % of Siliconöl AK 350, based on the total weight of the building material formulation of Ex. 8.

### INVENTIVE EXAMPLE 9

### Ex. 9

Contained 4 wt % of dispersion powder, based on the total weight of the building material formulation of Ex. 9.

The building material formulation was produced by method B.
The premix contained 4 wt % of deduster 7, based on the total weight of the premix. The building material formulation therefore contained 0.08 wt % of Siliconöl AK 350, based on the total weight of the building material formulation of Ex. 9.

### INVENTIVE EXAMPLE 10

### Ex. 10

Contained 4 wt % of dispersion powder, based on the total weight of the building material formulation of Ex. 10.

The building material formulation was produced by method B.
The premix contained 3 wt % of deduster 8, based on the total weight of the premix. The building material formulation therefore contained 0.08 wt % of refined rapeseed oil/colza oil, based on the total weight of the building material formulation of Ex. 10.

### INVENTIVE EXAMPLE 11

### Ex. 11

Contained 4 wt % of dispersion powder, based on the total weight of the building material formulation of Ex. 11.

The building material formulation was produced by method B.
The premix contained 30 wt % of deduster 8, based on the total weight of the premix. The building material formulation therefore contained 0.8 wt % of refined rapeseed oil/colza oil, based on the total weight of the building material formulation of Ex. 11.

### INVENTIVE EXAMPLE 12

### Ex. 12

The building material formulation is based on formulation 2 and contained 1 wt % of dispersion powder and 1 wt % of deduster 5, the amounts in wt % being based on the total weight of the building material formulation of Ex. 12. The building material formulation therefore contained 0.67 wt % of Siliconöl AK 10, based on the total weight of the building material formulation of Ex. 12. The building material formulation was produced by method A.

### COMPARATIVE EXAMPLE 13

### CEx. 13

Analogous to Inventive Example 12, with the difference that no deduster 5 was used.

### INVENTIVE EXAMPLE 14

### Ex. 14

The building material formulation is based on formulation 3 and contained 4.5 wt % of dispersion powder and 1 wt % of deduster 5, the amounts in wt % being based on the total weight of the building material formulation of Ex. 14. The building material formulation therefore contained 0.67 wt % of Siliconöl AK 10, based on the total weight of the building material formulation of Ex. 14. The building material formulation was produced by method A.

### COMPARATIVE EXAMPLE 15

### CEx. 15

Analogous to Inventive Example 14, with the difference that no deduster 5 was used.

### INVENTIVE EXAMPLE 16

### Ex. 16

Formulation 1 was used which contained 4 wt % of dispersion powder, based on the total weight of the building material formulation of Ex. 16.

The building material formulation was produced by method B.
The premix contained 4 wt % of deduster 2, based on the total weight of the premix. The building material formulation therefore contained 0.08 wt % of Siliconöl AK 10, based on the total weight of the building material formulation of Ex. 16.

### INVENTIVE EXAMPLE 17

### Ex. 17

Formulation 1 was used which contained 4 wt % of dispersion powder, based on the total weight of the building material formulation of Ex. 17.

The building material formulation was produced by method B.
The premix contained 3 wt % of deduster 9, based on the total weight of the premix. The building material formulation therefore contained 0.08 wt % of Catenex T121, based on the total weight of the building material formulation of Ex. 17.

### INVENTIVE EXAMPLE 18

### Ex. 18

Formulation 1 was used which contained 4 wt % of dispersion powder, based on the total weight of the building material formulation of Ex. 18.

The building material formulation was produced by method B.
The premix contained 30 wt % of deduster 9, based on the total weight of the premix. The building material formulation therefore contained 0.8 wt % of Catenex T121, based on the total weight of the building material formulation of Ex. 18.

Testing of the Building Material Formulations:

The building material formulations were investigated for their dusting behavior. For this purpose, 1000 g of each building material formulation were introduced carefully into a Toni mixer. A dust acquisition and measurement device (Gilian 5000 with rotameter and dust acquisition head, from Deha Haan & Wittmer GmbH) was mounted on the edge of the vessel but within the stirring vessel of the Toni mixer. The Toni mixer was then switched on and stirring was carried out at level 2 for 2 minutes, with visible eddying of dust. During this operation, dust was detected via the dust acquisition and measurement device. The pump of the dust acquisition and measurement device was set at a flow-through rate of 3.5 l/min and sucked in the air from its surroundings. The dust sucked in by the dust acquisition and measurement device was deposited on a filter (Macherey-Nagel MN 85/90, 37 mm diameter, Ref. No. 406 0037). The quantity of dust accumulated on the filter was determined gravimetrically after the end of the measurement, i.e., after the 2 minutes of stirring with the Toni mixer, and analyzed by thermogravimetry (DIN EN ISO 11358) for the inorganic and organic fractions.

To investigate the effect of storage of the building material formulations on dust evolution, the building material formulations of Inventive and Comparative Examples 12 to 15 were subjected to additional testing. A sample of each of these building material formulations was stored at 40° C. for 56 days immediately after its production as described above. Subsequently, the testing described above for determining the dusting behavior was carried out.

The results of the testing are listed in Tables 1 and 2. The figures given therein for dust evolution in ppm were determined by gravimetry from the quantity of dust accumulated on the filter, and are based on the 1000 g of the respective building material formulation that was introduced into the Toni mixer.

TABLE 1
Testing of dust evolution with formulation 1:

| | | Dust | Organic fraction |
|---|---|---|---|
| | Dust [ppm] | reduction^{a)} [%] | of dust^{b)} [%] |
| CEx. 1 | 27.7 | — | 3.0 |
| CEx. 2 | 22.3 | 20 | 2.0 |
| CEx. 3 | 14.1 | 50 | 2.0 |
| Ex. 4 | 22.0 | 20 | 2.1 |
| Ex. 5 | 13.1 | 50 | 2.2 |
| Ex. 6 | 10.4 | 60 | 2.0 |
| Ex. 7 | 1.3 | 95 | not determinable^{c)} |
| Ex. 8 | 23.8 | 15 | 2.0 |
| Ex. 9 | 20.9 | 25 | 2.2 |
| Ex. 10 | 13.2 | 20 | not determined |
| Ex. 11 | 1.3 | 90 | not determined |
| Ex. 16 | 17.3 | 40 | 2.2 |
| Ex. 17 | 8.2 | 70 | not determined |
| Ex. 18 | 1.1 | 95 | not determinable^{c)} |

^{a)}indicates the extent of reduced dusting by the respective example, based on the amount of dust determined in CEx. 1.
^{b)}based in each case on the total quantity of dust detected.
^{c)}The quantity of dust was so small that it could not be determined.

TABLE 2
Testing of dust evolution with formulations 2 and 3:

| | | | Dust | | Organic fraction | |
|---|---|---|---|---|---|---|
| | Dust [ppm] | | reduction^{a)} [%] | | of dust^{b)} [%] | |
| | w.s.^{c)} | 56 d^{d)} | w.s.^{c)} | 56 d^{d)} | w.s.^{c)} | 56 d^{d)} |
| Ex.12 | 1.6 | 1.5 | 80 | 95 | 3.1 | 1.4 |
| CEx.13 | 8.7 | 32.6 | | | 5.2 | 1.5 |
| Ex.14 | 3.6 | 1.7 | 80 | >95 | 6.3 | 3.3 |
| CEx.15 | 16.9 | 62.8 | | | 9.7 | 2.2 |

a)indicates the extent of reduced dusting by the respective example, based on the amount of dust determined in CEx.1.
b)based in each case on the total quantity of dust detected.
c)w.s.: without storage: testing took place directly after production of the building material formulation.
d)56 d: 56 days: following its production, the building material formulation was stored at 40° C. for 56 days and only then subjected to testing.

1. A method for producing building material formulations in a form of dry mixes, wherein:
(a) one or more dust reducer agents are applied to one or more inorganic supports, to form supported dust reducer agents,
the inorganic supports having a porosity of ≧65%, and
the dust reducer agents being members selected from the group consisting of fatty acids, fatty acid derivatives, natural oils, hydrocarbons, and polysiloxanes consisting of units of the general formula R_{c}Si(OR′)_{d}(OH)ₑO_{(4-c-d-e)/2} with c=0 to 3, d=0 to 3, e=0 to 3, in which a sum c+d+e per unit is not more than 3.5, in which in each case R is identical or different and denotes branched or unbranched, optionally substituted hydrocarbon radicals having 1 to 22 carbon atoms, and R′ denotes identical or different, optionally substituted hydrocarbon radicals having in each case 1 to 6 carbon atoms, and
(b) the supported dust reducer agents obtained in step (a) are mixed with one or more mineral binders, one or more polymers based on one or more ethylenically unsaturated monomers, optionally one or more fillers, and optionally one or more additives.

2. The method for producing building material formulations as claimed in claim 1, wherein
premixes are produced by mixing one or more supported dust reducer agents and one or more components selected from the group consisting of polymers based on one or more ethylenically unsaturated monomers, fillers, and additives, and
the resulting premixes are mixed with one or more mineral binders, optionally one or more fillers, optionally one or more polymers based on one or more ethylenically unsaturated monomers, and optionally one or more additives.

3. The method for producing building material formulations as claimed in claim 1, wherein the one or more dust reducer agents are members selected from the group consisting of
polysiloxanes of the general formula R′″ₐR″₃₋ₐSiO(SiR″₂O)ₙSiR″₃₋ₐR′″ₐ, in which the individual radicals R″ independently of one another may adopt the definitions indicated for R and (OR′) in claim 1, R′″ is OH, a denotes an integral value between 0 and 3, and n adopts an integral value between 0 and 500,
fatty acids or fatty acid derivatives selected from the group consisting of saturated and unsaturated fatty acids having 8 to 22 C atoms, their metal soaps, their amides, and their esters with monohydric alcohols having 1 to 14 C atoms, with glycol, with polyglycol, with polyalkylene glycol, with glycerol, with mono-, di-, or triethanolamine, with monosaccharides, and with polyhydroxy compounds,
natural oils comprising one or more carboxylic acids or their esters, the carboxylic acids containing 4 to 28 carbon atoms and the alcohols containing 1 to 12 carbon atoms, and
hydrocarbons having boiling points or boiling ranges from 100 to 400° C. (under a pressure of 1 bar) and more than 10 carbon atoms.

4. The method for producing building material formulations as claimed in claim 1, wherein the one or more dust reducer agents are selected from the group consisting of dimethylpolysiloxanes, dimethylpolysiloxanes endblocked with trimethylsiloxy groups, and dimethylpolysiloxanes having Si—OH groups in the terminal units.

5. The method for producing building material formulations as claimed in claim 1, wherein the inorganic supports are based on carbonates, silicates, or other inorganic oxides or minerals.

6. The method for producing building material formulations as claimed in claim 1, wherein the inorganic supports are members selected from the group consisting of magnesium carbonate, calcium carbonate, quartz, cristobalite, silica, diatomaceous earth, kieselguhr, siliceous earth, magnesium hydrosilicates, microsilica, perlite, Dicalite, zeolites, Poraver (foam glass), titanium dioxide, alumina, bleaching earths, kaolin, talc, mica, activated aluminum oxide, vermiculites, and phosphates.

7. The method for producing building material formulations as claimed in claim 1, wherein in the inorganic supports a fraction of pores having a pore diameter of ≧2000 nm is ≧10%, based on a total number of pores in the inorganic supports (determined by mercury porosimetry).

8. The method for producing building material formulations as claimed in claim 1, wherein in the inorganic supports a fraction of pores having a pore diameter of ≧20,000 nm is ≧5%, based on a total number of pores in the inorganic supports (determined by mercury porosimetry).

9. The method for producing building material formulations as claimed in claim 1, wherein the inorganic supports have a density of 50 to 300 g/dm³ (determined in accordance with DIN EN ISO 787-10).

10. The method for producing building material formulations as claimed in claim 1, wherein the supported dust reducer agents comprise 5 to 90 wt % of inorganic supports, based on a total weight of the dust reducer agents and inorganic supports.

11. The method for producing building material formulations as claimed in claim 1, wherein the supported dust reducer agents comprise 10 to 95 wt % of dust reducer agents, based on a weight of the inorganic supports.

12. The method for producing building material formulations as claimed in claim 1, wherein the building material formulations comprise 2 to 70 wt % of mineral binders, 0.001 to 10 wt % of supported dust reducer agents, 1 to 60 wt % of polymers, optionally 10 to 85 wt % of fillers, the figures in wt % being based on a dry weight of the building material formulations and adding up in total to 100 wt %.

13. The method for producing building material formulations as claimed in claim 1, wherein the dust reducer agents are present at 0.001 to 5 wt % in the building material formulations, based on a dry weight of the building material formulations.

14. Building material formulations in a form of dry mixes obtainable by the method of claim 1.

15. The method of claim 1, wherein the building material formulations are tile adhesives, jointing mortars, adhesives for producing thermal insulation composite systems, reinforcing compounds, self-leveling compounds, repair mortars, or plasters, fine mineral plasters, grouts, skim coats, or concrete.

16. The method for producing building material formulations as claimed in claim 2, wherein the one or more dust reducer agents are members selected from the group consisting of
polysiloxanes of the general formula R′″ₐR″₃₋ₐSiO(SiR″₂O)ₙSiR″₃₋ₐR′″ₐ, in which the individual radicals R″ independently of one another may adopt the definitions indicated for R and (OR′) in claim 1, R′″ is OH, a denotes an integral value between 0 and 3, and n adopts an integral value between 0 and 500,
fatty acids or fatty acid derivatives selected from the group consisting of saturated and unsaturated fatty acids having 8 to 22 C atoms, their metal soaps, their amides, and their esters with monohydric alcohols having 1 to 14 C atoms, with glycol, with polyglycol, with polyalkylene glycol, with glycerol, with mono-, di-, or triethanolamine, with monosaccharides, and with polyhydroxy compounds,
natural oils comprising one or more carboxylic acids or their esters, the carboxylic acids containing 4 to 28 carbon atoms and the alcohols containing 1 to 12 carbon atoms, and
hydrocarbons having boiling points or boiling ranges from 100 to 400° C. (under a pressure of 1 bar) and more than 10 carbon atoms.

17. The method for producing building material formulations as claimed in claim 16, wherein:
the one or more dust reducer agents are selected from the group consisting of dimethylpolysiloxanes, dimethylpolysiloxanes endblocked with trimethylsiloxy groups, and dimethylpolysiloxanes having Si—OH groups in the terminal units;
the inorganic supports are members selected from the group consisting of magnesium carbonate, calcium carbonate, quartz, cristobalite, silica, diatomaceous earth, kieselguhr, siliceous earth, magnesium hydrosilicates, microsilica, perlite, Dicalite, zeolites, Poraver (foam glass), titanium dioxide, alumina, bleaching earths, kaolin, talc, mica, activated aluminum oxide, vermiculites, and phosphates;
in the inorganic supports a fraction of pores having a pore diameter of ≧2000 nm is ≧10%, based on a total number of pores in the inorganic supports (determined by mercury porosimetry);
in the inorganic supports a fraction of pores having a pore diameter of ≧20,000 nm is ≧5%, based on a total number of pores in the inorganic supports (determined by mercury porosimetry); and
the inorganic supports have a density of 50 to 300 g/dm³ (determined in accordance with DIN EN ISO 787-10).

18. The method for producing building material formulations as claimed in claim 17, wherein:
the supported dust reducer agents comprise 5 to 90 wt % of inorganic supports, based on a total weight of the dust reducer agents and inorganic supports; and
the supported dust reducer agents comprise 10 to 95 wt % of dust reducer agents, based on a weight of the inorganic supports.

19. The method for producing building material formulations as claimed in claim 18, wherein the building material formulations comprise 2 to 70 wt % of mineral binders, 0.001 to 10 wt % of supported dust reducer agents, 1 to 60 wt % of polymers, optionally 10 to 85 wt % of fillers, the figures in wt % being based on a dry weight of the building material formulations and adding up in total to 100 wt %.

20. The method for producing building material formulations as claimed in claim 19, wherein the dust reducer agents are present at 0.001 to 5 wt % in the building material formulations, based on a dry weight of the building material formulations.
